(19) United States
(12) Patent Application Publication
(10) Pub. No.: US 2012/0144174 A1
(43) Pub. Date: Jun. 7, 2012

(54) MULTIFLOW METHOD AND APPARATUS FOR OPERATION FUSION

(75) Inventors: Emil Talpes, Sunnyvale, CA (US); Ganesh Venkataramanan, Sunnyvale, CA (US)

(73) Assignee: ADVANCED MICRO DEVICES, INC., Sunnyvale, CA (US)

(21) Appl. No.: 12/957,699

(22) Filed: Dec. 1, 2010

(51) Int. Cl. G06F 9/22

(52) U.S. Cl. 712/246; 712/E09.005

(57) ABSTRACT

A method and apparatus for utilizing scheduling resources in a processor are disclosed. A complex operation is assigned for execution as two micro-operations; a first micro-operation and a second micro-operation. The first micro-operation, which may be an address-generation operation, is executed using at least one of a first processing unit or a load and store unit and the second micro-operation, which may be an execution operation, is executed using a second processing unit, where at least one operand of the second micro-operation is an outcome of the first micro-operation.

### FIELD OF INVENTION

This application is related to processor technology and operation fusion, in particular.

### BACKGROUND

As processor systems evolve, performance speed is of special importance. In order for fast performance to be achieved technological advances are accomplished in terms of the scale of on-chip processors as well as more efficient achievement of computing tasks. It is to this end that it has become increasingly important to discover ways to make processors run more efficiently. It is additionally important to achieve computing tasks while preserving pipeline and buffer resources as much as possible and reducing dispatch bandwidth and queue occupancy resources in the processor execution unit.

Processors, including those implementing x86 instructions, typically execute instructions on memory values, such as adding a value from a memory location to a value from a register. To accomplish the task at this instance, typical processors dispatch the memory value to a temporary location and thereafter, execute an addition instruction that will dispatch the value from the temporary memory location and perform addition to a register. Therefore, in performing the addition, two values are dispatched and two slots are occupied within the processor's internal memory buffers (one in loading the memory value from its memory location and another in dispatching it from a temporary memory location). Had less dispatching resources been used in the execution of computing tasks, then the processor may free more of its valuable resources, and therefore achieve more efficient task computing.

Therefore, it would be desirable to have a method and apparatus that performs computing tasks with decreased memory buffer usage and decreased dispatch bandwidth usage.

### SUMMARY OF EMBODIMENTS

Embodiments of a method and apparatus for utilizing scheduling resources in a processor are provided. A complex operation is assigned for execution as two micro-operations; a first micro-operation and a second micro-operation. The first micro-operation is executed using at least one of a first processing unit or a load and store unit and the second micro-operation is executed using a second processing unit, where at least one operand of the second micro-operation is an outcome of the first micro-operation.

In another embodiment, the outcome of the first micro-operation is placed in an execution-side register. The first micro-operation may comprise moving a value from a memory unit. The second micro-operation may be one of addition; addition with carry; subtraction; subtraction with borrow; conjunction; disjunction; exclusive disjunction; a shift; or a rotate. The first micro-operation may be associated with a first physical register number (PRN) and the second micro-operation is associated with a second PRN, wherein the first PRN and the second PRN are different. The first micro-operation may have an operand of a first operand size and the second micro-operation may have an operand of a second operand size, wherein the first operand size and the second operand size may be the same.

### BRIEF DESCRIPTION OF THE DRAWINGS

A more detailed understanding may be had from the following description, given by way of example in conjunction with the accompanying drawings wherein:

FIG. 1 shows an example of a processor and its components in accordance with an embodiment of the invention.

### DETAILED DESCRIPTION

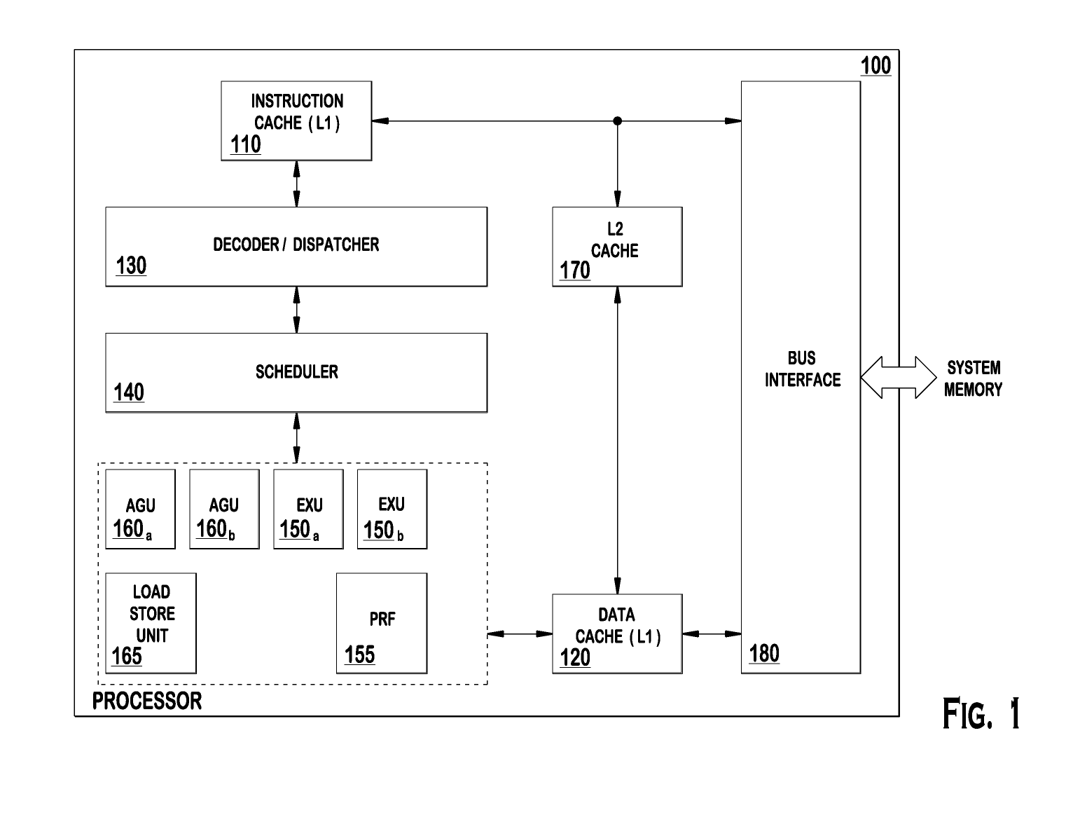

FIG. 1 shows an embodiment of a processor. Processor 100 is configured to execute instructions stored in a system memory. Many of these instructions may operate on data also stored in the system memory. It is noted that the system memory may be physically distributed throughout a computer system and may be accessed by one or more processors, such as processor 100. In one embodiment, processor 100 is an example of a microprocessor which implements an x86 architecture. However, other embodiments are contemplated which may include any type of processor such as, for example, a digital signal processor (DSP), a graphics processing unit (GPU), an applications processor, combinations thereof, or the like.

In the illustrated embodiment, processor 100 includes a level 1 (L1) instruction cache 110 and an L1 data cache 120 although various scenarios may be used for the caches included in processor 100. Further, processor 100 includes an on-chip level 2 (L2) cache 170 which is coupled between L1 instruction cache 110, L1 data cache 120, and system memory. It is noted that alternative embodiments are contemplated in which L2 cache memory 170 resides off-chip.

Processor 100 also includes an instruction decoder 130, which is coupled to instruction cache 110 to dispatch operations to a scheduler 140. The decoder 130 may be able to extract and decode multiple instructions at the same time and dispatch these to the scheduler 140. In some embodiments, the decoder can decode 4 x86 instructions per clock cycle. Processor 100 may include two execution units (EXUs) 150ₐ, 150_{b} which may be configured to perform accesses to a data cache 120 and execute integer operations. Further, the first EXU 150ₐ may be configured to perform multiplication operations, whereas the second EXU 150_{b} may be configured to perform division operations.

Results generated by execution units 150ₐ, 150_{b} may be used as operand values for subsequently issued instructions and/or stored to physical register file (PRF) 155 or elsewhere in processor 100 memory. Processor 100 also includes two Address Generation Units (AGUs) 160ₐ, 160_{b}. The AGUs 160ₐ and 160_{b} are capable of performing address generate operations and generating effective addresses. The AGUs 160ₐ, 160_{b} may be configured to perform address generation for load and store memory operations to be performed by load/store unit 165.

A scheduler 140 is coupled to receive operations and to issue operations to the two EXUs 150ₐ and 150_{b} and the two AGUs 160ₐ and 160_{b}. In some embodiments, each scheduler may be associated with one of an execution unit or an address generation unit, whereas in other embodiments, a single scheduler may issue operations to more than one of an execution unit or an address generation unit.

Instruction cache 110 may store instructions before execution. Further, in one embodiment instruction cache 110 may be implemented in static random access memory (SRAM), although other embodiments are contemplated which may include other types of memory.

Instruction decoder 130 may be configured to decode instructions into operations which may be either directly decoded or indirectly decoded using operations stored within an on-chip read-only memory (ROM). Instruction decoder 130 may decode certain instructions into operations executable within execution units. Simple instructions, or micro operations (uops) may correspond to a single operation. In some embodiments, complex instructions (Cops) may correspond to multiple operations.

Scheduler 140 may include one or more scheduler units (e.g. an integer scheduler unit and a floating point scheduler unit). It is noted that as used herein, a scheduler is a device that detects when operations are ready for execution and issues ready operations to one or more execution units. Each scheduler 140 may be capable of holding operation information (e.g., bit encoded execution bits as well as operand values, operand tags, and/or immediate data) for several pending operations awaiting issue to an execution unit 150.

In other embodiments, processor 100 may be a superscalar processor, in which case multiple execution units are included (e.g., a plurality of integer execution units (not shown)) configured to perform integer arithmetic operations of addition and subtraction, as well as shifts, rotates, logical operations, and branch operations. In addition, one or more floating-point units (not shown) may also be included to accommodate floating-point operations.

Load/store unit 165 may be configured to provide an interface between execution unit, e.g. 150ₐ, and data cache 120. In one embodiment, load/store unit 165 may be configured with a load/store buffer (not shown) with several storage locations for data and address information for pending loads or stores.

Data cache 120 is a cache memory provided to store data being transferred between load/store unit 165 and the system memory. Similar to instruction cache 110 described above, data cache 120 may be implemented in a variety of specific memory configurations, including a set associative configuration.

L2 cache 170 is also a cache memory and it may be configured to store instructions and/or data. In the illustrated embodiment, L2 cache 170 is an on-chip cache and may be configured as either fully associative or set associative or a combination of both. In one embodiment, L2 cache 170 may store a plurality of cache lines where the number of bytes within a given cache line of L2 cache 170 is implementation specific. It is noted that L2 cache 170 may include control circuitry (not shown in FIG. 1) for scheduling requests, controlling cache line fills and replacements, and coherency, for example.

Bus interface unit 180 may be configured to transfer instructions and data between system memory and L2 cache 170 and between system memory and instruction cache 110 and data cache 120. In one embodiment, bus interface unit 180 may include buffers (not shown) for buffering write transactions during write cycle streamlining. In one particular embodiment of processor 100 employing the x86 processor architecture, instruction cache 110 and data cache 120 may be physically addressed. The method and apparatus disclosed herein may be performed in any processor including but not limited to large-scale processors used in computer and game console processors.

In another embodiment, processor 100 runs x86 assembly language, wherein, x86 instructions, or machine language, are used to accomplish the processor's computing tasks. An x86 nm emonic may have one or more operands which translate into one or more bytes of an operation code. In one embodiment, an instance of an x86 nm emonic is shown:

mov rax, [1234]

The instruction, as shown above, moves into register rax (in PRF 155) the contents of memory location, or position, 1234. In this embodiment, the destination is before the source for mnemonic mov. Additionally, the source can be any one of a memory location, a register, or a value.

Another example of an x86 instruction is the “add” instruction. For instance, “add rbx, rax” adds the contents of registers rax and rbx and stores the result in register rbx. Had the source operand been memory location [base+index+imm], wherein base, index, and imm represent values that point to the particular memory location to be added to rbx, then the instruction is represented as:

add rax, [base+index+imm]

In some cases, the add instruction presented above is treated as two separate instructions; a first load instruction and a second add instruction. To execute this instruction, the value of the sum of base, index, imm is determined, then a load instruction is performed. When the add instruction is executed as two separate instructions, the load instruction causes the value of memory location [base+index+imm] to be placed in a temporary memory location. Then add instruction is performed which adds the contents of the temporary memory location to register rax and places the outcome in register rax. Given that the two instructions are separate, when a processor performs the second add operation, the processor may not be aware of the fact that a load operation was performed as part of this two step process, and, therefore, the add operation is simply viewed as adding a temporary location value to a register.

Those skilled in the art will recognize that the first load may involve the steps of scheduling and decoding the first load instruction and dispatching the memory location value, e.g. [base+index+imm], to a temporary memory location. The second add instruction after scheduling and decoding will dispatch the value from the temporary memory location and perform an addition to register rax. Therefore two dispatches are performed; one for dispatching the memory value in location [base+index+imm] to a temporary memory location and another for dispatching the value from the temporary memory location to the execution unit to be executed. Additionally, two spaces are occupied in the processor's internal memory buffers.

The add operation may be represented as follows:

add dest_rax, dest_ldtmp, src_rax, src_base, src_indx.

Wherein ldtmp represents the temporary memory location.

x86 instructions may be categorized in terms of the source and destination associated with them. For instance, the mov instruction has one source, defined in the example above as memory location [1234], and one destination, register rax. However, x86 instruction “div”, which performs unsigned division, has two sources, one for each of the dividend and the divisor, and two destinations, one for each of the quotient and the remainder. For instance, an x86 unsigned division may be represented as:

div rdx, [1234]

where the content of register rdx is divided by the contents of memory location 1234. Accordingly, the quotient of the division is stored in register rax and the remainder is stored in register rdx. Further, the x86 instruction “pop”, which pops data from a stack, requires two destinations as well, and the “mul” instruction, which multiplies two values, writes two values, one for the result and another for an operation overflow.

Accordingly, the scheduler 140 must be capable of scheduling instructions to its execution units that are capable of writing results to two destinations. Further, the scheduler 140 must also be capable of reading up to four sources. However, many x86 instructions do not require as many as four sources and 2 destinations for their execution. For instance, the addition instruction “add” requires two sources and one destination, where

add rbx, rax

which in this instance, adds register sources, rbx and rax, and stores the result in register rbx. Therefore, in this embodiment, when the scheduler 140 schedules the execution of the addition instruction to EXU 150ₐ, for instance, many of the scheduling resources available will not be used.

Operation fusion may combine operations to produce complex operations (Cops) that utilize more of the available scheduling resources. In some embodiments, one operation is performed on the address generation side of a processor, e.g. by AGUs 160ₐ and 160_{b}, and another operation is performed on the execution-side of a processor, e.g. by EXU 150ₐ and 150_{b}. Further, other embodiments call for operation fusion in instances where a second operation is executed, or performed, after a first operation is executed. Furthermore, embodiments of operation fusion and complex operation are contemplated, wherein a first part of the fused operation is load operation and a second is an execution-only operation, e.g. performed by EXU 150ₐ and 150_{b}, and is dependent on the first part. Other embodiments of operation fusion may be contemplated by those skilled in the art.

To execute the following as a complex operation:

add rbx, [base+indx+imm]

it is determined that in operation fusion the instruction is to be performed as a first address generation-side load operation, e.g. handled by the AGU, 160ₐ or 160_{b}, in processor 100, and a second execution-side add operation, e.g. handled by the EXU, 150ₐ and 150_{b}, in processor 100. The determination of the first address generation flow and the second execution flow may be done by the decoder 130. As mentioned previously, the decoder 130 is responsible for converting x86 instruction into internal format instructions that are capable of being operated on by execution units of processor 100. Therefore, the complex operation may be scheduled as two fused simple operations, or micro operations (a load operation and an execution operation):

mov rax, [base+indx+disp]

add rbx, rax

The mov operation is performed by the AGU, e.g. AGU 160ₐ in processor 100, wherein base+indx+disp is determined and moved to register rax, e.g. in physical register file (PRF) 155, by a load and store unit, e.g. load and store unit 165 in processor 100. Thereafter, the execution-side of the complex operation is performed by the EXU, e.g. EXU 150ₐ in processor 100, wherein the contents of register rax is added to the contents of register rbx and the result placed in register rbx. Registers rab and rbx may be in the physical register file 155 of processor 100. A decoder 130 may employ circuitry or logic that detects operation fusion and matches the registers of the two operations. Here, for instance, the destinations of the load operation (register rax) and that of the add operation (register rbx) are different. In some embodiments, the result of the load operation stored in register rax may be used as an operand for another operation.

This complex fused operation is, therefore, associated with one dispatch, from a memory location to register rax, and only occupies one space in internal memory buffers (as opposed to two spaces: one due to dispatching a memory value to an temporary memory location for temporary keeping, and another due to dispatching the value from the temporary memory location to the execution unit to be operated upon). Additionally, it results in less scheduling queue occupancy and faster queue retirement. Those skilled in the art will appreciate the performance improvements associated with employing operation fusion that results from lighter queue occupancies.

Further, as compared to add rbx, [base+indx+imm], which uses two sources and one destination, the corresponding complex operation uses a total of three sources and two destinations (the mov operation has one sources and one destination and the add operation has two sources and one destination), thereby utilizing unused x86 scheduling resources (since an x86 scheduler is capable of handling up to four sources and two destinations). Therefore, complex operations may be handled within the limitations of an x86 scheduler.

In operation fusion any number of registers may be used as a second destination, whereas without employing operation fusion, there may be only two registers that are used as a second destination for certain instructions (for instance register rdx is used as the remainder destination for div, and register rsp is used as a second destination for instructions pop and ret). A decoder 130 may require more signaling options to point to the second destination register. Whereas before only 2 bits of signaling may be used to specify a second destination (one bit for requesting a second destination and another bit for selecting between rdx and rsp as a second destination), in operation fusion n bits may be needed to select between 2ⁿ register destinations.

In some embodiments, the destination of the load operation and the execution operation are different. For instance, another way to perform the addition: add rbx, [base+indx+imm] is by setting up a complex operation that features register rax for the destination of both the load operation and the execution operation:

mov rax, [base+indx+disp]

add rax, rbx

Here two flows of the complex operation are used; a first flow is a load or address generation flow, where a memory value is moved to a register location. Another flow is the execution flow, where a register addition is performed. Register rax is the destination of both the load and execution flows. In this instance, the moving operation has one source and one destination and the addition operation has two sources and one destination. Therefore, three sources and two destinations are required for the complex operation, which is less than the maximum capacity of an x86 scheduler (four sources, two destinations). However, dispatch bandwidth is reduced because only one dispatch slot is used for the fused operation.

Many examples of execution-side operations may be contemplated by those skilled in the art, including addition with carry (adc), subtraction, subtraction with borrow (sbb), conjunction (and), disjunction (or), exclusive disjunction (xor), shifts and rotates. In some embodiments, the address generation-side operation and the execution-side operation have the same operand size. Furthermore, the address-generation-side component and the execution-side component may have different physical register numbers (PRNs).

Although features and elements are described above in particular combinations, each feature or element can be used alone without the other features and elements or in various combinations with or without other features and elements. The methods or flow charts provided herein may be implemented in a computer program, software, or firmware incorporated in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Embodiments of the present invention may be represented as instructions and data stored in a computer-readable storage medium. For example, aspects of the present invention may be implemented using Verilog, which is a hardware description language (HDL). When processed, Verilog data instructions may generate other intermediary data, (e.g., netlists, GDS data, or the like), that may be used to perform a manufacturing process implemented in a semiconductor fabrication facility. The manufacturing process may be adapted to manufacture semiconductor devices (e.g., processors) that embody various aspects of the present invention.

Suitable processors include, by way of example, a general purpose processor, a special purpose processor, a conventional processor, a digital signal processor (DSP), a plurality of microprocessors, a graphics processing unit (GPU), a DSP core, a controller, a microcontroller, application specific integrated circuits (ASICs), field programmable gate arrays (FPGAs), any other type of integrated circuit (IC), and/or a state machine, or combinations thereof.

What is claimed is:

1. A method for utilizing scheduling resources in a processor, the method comprising:
assigning a complex operation as two micro-operations, a first micro-operation and a second micro-operation;
executing the first micro-operation using at least one of a first processing unit or a load and store unit; and
executing the second micro-operation using a second processing unit, wherein at least one operand of the second micro-operation is an outcome of the first micro-operation.

2. The method of claim 1, wherein an outcome of the first micro-operation is placed in a processor register.

3. The method of claim 2, wherein the first micro-operation is a moving operation.

4. The method of claim 1, wherein the second micro-operation is one of addition; addition with carry; subtraction; subtraction with borrow; conjunction; disjunction; exclusive disjunction; a shift; or a rotate.

5. The method of claim 1, wherein the first micro-operation is associated with a first physical register number (PRN) and the second micro-operation is associated with a second PRN, and wherein the first PRN and the second PRN are different.

6. The method of claim 1, wherein the first micro-operation has an operand of a first operand size and the second micro-operation has an operand of a second operand size, and wherein the first operand size and the second operand size are the same.

7. The method of claim 1, further comprising:
providing a scheduler, wherein the scheduler assigns the first micro-operation and the second micro-operation as two dependent flows.

8. A processor comprising:
a decoder configured to decode and assign a complex operation to a scheduler as two micro-operations, a first micro-operation and a second micro-operation;
a scheduler configured to schedule the complex operation for execution by one or more of an address generation unit (AGU) configured to perform address generation computations; one or more of a load and store unit configured to load and store values from memory; or one or more of an execution unit (EXU) configured to execute operations.

9. The processor of claim 8, wherein an outcome of the first micro-operation is placed in an execution-side register.

10. The processor of claim 9, wherein the first micro-operation is a moving operation.

11. The processor of claim 8, wherein the second micro-operation is one of addition; addition with carry; subtraction; subtraction with borrow; conjunction; disjunction; exclusive disjunction; a shift; or a rotate.

12. The processor of claim 8, wherein the first micro-operation is associated with a first physical register number (PRN) and the second micro-operation is associated with a second PRN, and wherein the first PRN and the second PRN are different.

13. processor of claim 8, wherein the first micro-operation has an operand of a first operand size and the second micro-operation has an operand of a second operand size, and wherein the first operand size and the second operand size are the same.

14. A computer system comprising:
a memory;
a decoder configured to decode and assign a complex operation to a scheduler as two micro-operations; a first micro-operation and a second micro-operation;
a scheduler configured to schedule the complex operation for execution by one or more of an address generation unit (AGU) configured to perform address generation computations; one or more of a load and store unit configured to load and store values from memory; or one or more of an execution unit (EXU) configured to execute operations.

15. The computer system of claim 14, wherein an outcome of the first micro-operation is placed in an execution-side register.

16. The computer system of claim 15, wherein the first micro-operation is a moving operation.

17. The computer system of claim 14, wherein the second micro-operation is one of addition; addition with carry; subtraction; subtraction with borrow; conjunction; disjunction; exclusive disjunction; a shift; or a rotate.

18. The computer system of claim 14, wherein the first micro-operation is associated with a first physical register number (PRN) and the second micro-operation is associated with a second PRN, and wherein the first PRN and the second PRN are different.

19. The computer system of claim 14, wherein the first micro-operation has an operand of a first operand size and the second micro-operation has an operand of a second operand size, and wherein the first operand size and the second operand size are the same.

20. A computer-readable storage medium storing a set of instructions for execution by a general purpose computer utilize scheduling resources in a processor scheduler, the set of instructions comprising:
an assigning code segment for assigning a complex operation as two micro-operations; a first micro-operation and a second micro-operation;
an executing code segment for executing the first micro-operation using at least one of a first processing unit; or a load and store unit; and
an executing code segment for executing the second micro-operation using a second processing unit, wherein at least one operand of the second micro-operation is an outcome of the first micro-operation.

21. The computer readable storage medium of claim 20, wherein the set of instructions are hardware description language (HDL) instructions used for the manufacture of a device.
